(19) United States
(12) Patent Application Publication
(10) Pub. No.: US 2014/0139060 A1
(43) Pub. Date: May 22, 2014

(54) BAND ATTENUATION FILTER

(71) Applicant: Pierre Pilard, Saint Remy Sur Creuse (FR)

(72) Inventor: Pierre Pilard, Saint Remy Sur Creuse (FR)

(73) Assignee: Valeo Systèmes d'Essuyage, Le Mesnil Saint Denis (FR)

(21) Appl. No.: 14/128,168

(22) PCT Filed: Jun. 21, 2012
(86) PCT No.: PCT/EP2012/061924

§ 371 Date: Dec. 20, 2013

(30) Foreign Application Priority Data
Jun. 21, 2011 (FR) 1155465

(51) Int. Cl. H02K 11/02

(52) U.S. Cl. CPC H02K 11/026
USPC 310/72

(57) ABSTRACT

A band attenuator/eliminator filter (F) for the electromagnetic emissions of a brushed DC motor. This filter comprises at least one gamma filter (G) with capacitive (C1)/reactive (L1) impedance which is intended to be connected between the motor positive power supply input (M+), the motor negative power supply input (M−) and the negative terminal (B−) of the battery. The capacitive impedance (C1) is intended to be connected between the motor negative power supply input (M−) and the motor positive power supply input (M+). A reactive impedance (L2) is provided and intended to be connected in series between the motor positive power supply input (M+) and the positive terminal of the battery (B+).

Application to motor vehicle windshield wiper motors.

The invention relates to a band attenuator/eliminator filter for the electromagnetic emissions of a brushed DC motor.

DC motors used for motor vehicle equipment, notably windshield wiper motors, comprise a rotary commutator on the sectors of which brushes in contact with these sectors supply power to the armature thus driving the motor.

When this type of motor is in operation, contact between the brushes and the successive discrete sectors of the commutator causes transient switching phenomena as the successive electrical contact of the brushes switches between the discrete sectors of the rotary commutator.

These transient phenomena generate parasitic noise and/or interference which can be analyzed as impulses with an erratic harmonic frequency structure, at very high frequency but at high amplitude, particularly when the brushes switch contact with the successive sectors of the commutator.

This parasitic noise and/or interference spreads with no great difficulty along the motor vehicle power supply and/or signal transmission lines.

That being so, they would appear to be detrimental not only to the comfort of the users of the vehicle, when this parasitic noise and/or interference spreads, for example, over the audio circuits of a radio frequency receiver of the vehicle, but also to the correct operation, or even the safety, of the vehicle, when it spreads along the command, control or regulation lines of the operating parts of the vehicle, such as notably the components that control speed and/or braking.

This parasitic noise and/or interference is also detrimental to the correct operation of the onboard memory and calculation circuits with which present-day motor vehicles are equipped.

Included among the solutions of the prior art used to reduce the amplitude of this parasitic noise and/or interference, mention may be made of EMC filters (EMC standing for ElectroMagnetic Compatibility), which usually comprise an inductance/capacitance filter system interposed between the connection terminals of the motor and the power supply terminals of the battery.

Bearing in mind the inductance/capacitance values normally employed, this type of filter makes it possible to achieve suitable attenuation of the parasitic noise and/or interference for frequencies with harmonic components of below around 100 MHz.

Other solutions have been proposed in an attempt to reduce or eliminate parasitic noise and/or interference generated by contact between the brushes and the sectors of the commutator in a DC motor.

Included among these proposed solutions are circuits of the capacitive filter type to which one or more diodes are added. The added diodes have the objective of essentially clipping the pulses or spikes on the parasitic noise and/or interference signals. Such a solution is described for example in patent US 3 732 285.

Another solution, like the one described by application EP 336 530, consists for example in providing HF band filtering using an HF circuit and LF band filtering using an LF circuit.

This solution appears to be complicated to implement and entails the building and installation of multiple circuits.

It is an object of the present invention to overcome the disadvantages of the prior art solutions for filtering the electromagnetic emissions of DC motors by using a single band filtering structure in a frequency range comprised between 60 MHz and 1.5 GHz.

It is another object of the present invention to implement a band attenuator/eliminator filter for the electromagnetic emissions of a brushed DC motor that is entirely compatible with current EMC filters and can therefore be added in cascade to and/or incorporated into the latter.

The band attenuator/eliminator filter for the electromagnetic emissions of a brushed DC motor that forms the subject of the invention is more particularly intended for windshield wiper motors. It is notable in that it comprises at least one gamma filter with capacitive/reactive impedance intended to be connected between the motor positive power supply input, the motor negative power supply input and the battery negative terminal, the capacitive impedance being intended to be connected between the motor negative power supply input and the motor positive power supply input, and a reactive impedance intended to be connected in series between the motor positive power supply input and the battery positive terminal.

The band attenuator/eliminator filter that forms the subject of the invention is notable in that the reactive impedances have an impedance in excess of 100 Ohms in a frequency band comprised between 60 MHz and 1.5 GHz.

The band attenuator/eliminator filter that forms the subject of the invention is also notable in that the capacitive impedance consists of a capacitor with a capacitance comprised between 1 pF and 500 nF, preferably comprised between 5 and 10 pF.

The band attenuator/eliminator filter that forms the subject of the invention is also notable in that it further comprises a capacitive impedance connected as a shunt across the free terminals of the reactive impedances to form a symmetric closed filtering cell formed of a first gamma filter, consisting of the gamma filter, and of a second gamma filter, mounted top to tail with the first gamma filter and formed by the series reactive impedance and the capacitive impedance connected as shunt.

The band attenuator/eliminator filter that forms the subject of the invention is also notable in that the capacitive impedance connected as shunt consists of a capacitive impedance with a capacitance comprised between 1 pF and 500 nF.

The band attenuator/eliminator filter that forms the subject of the invention is also notable in that the capacitive impedance connected as shunt is formed of a first capacitor and a second capacitor which are connected in series and the mid-point of which is intended to be connected to the ground potential of the motor.

The band attenuator/eliminator filter that forms the subject of the invention is notable in that the first capacitance and the second capacitance which are connected in series consist of a capacitor with the same electrical capacitance.

The band attenuator/eliminator filter that forms the subject of the invention is, according to one particular embodiment, notable in that this filter is connected between the motor positive and negative power supply terminals and the positive and negative power supply terminals of the battery, this band attenuator/eliminator filter being inserted between the electromagnetic compatibility filter incorporated into the motor and the power supply battery.

The band attenuator/eliminator filter that forms the subject of the invention is, according to one advantageous embodiment, notable in that this filter is incorporated directly into the casing of the electromagnetic compatibility filter.

The band attenuator/eliminator filter that forms the subject of the invention is, according to another advantageous embodiment, notable in that this filter is retro-fitted between the electromagnetic compatibility filter incorporated into the motor and the power supply battery.

According to another embodiment, the band attenuator/eliminator filter that forms the subject of the invention is notable in that at least one reactive impedance consists of a ferrite core self-inductance coil.

According to yet another embodiment, the band attenuator/eliminator filter that forms the subject of the invention is notable in that at least one capacitor is of ceramic capacitor type.

The band attenuator/eliminator filter according to the invention can thus be applied to equipment of brushed DC motors for motor vehicles, notably windshield wiper motors.

The invention therefore also covers a brushed DC motor comprising a band attenuator/eliminator filter according to any one of the above definitions, and the use of such a motor in a motor vehicle, notably as a windshield wiper motor.

The band attenuator/eliminator filter for the electromagnetic emissions of a brushed DC motor that forms the subject of the invention will be better understood from reading the description and from studying the following drawings, in which:

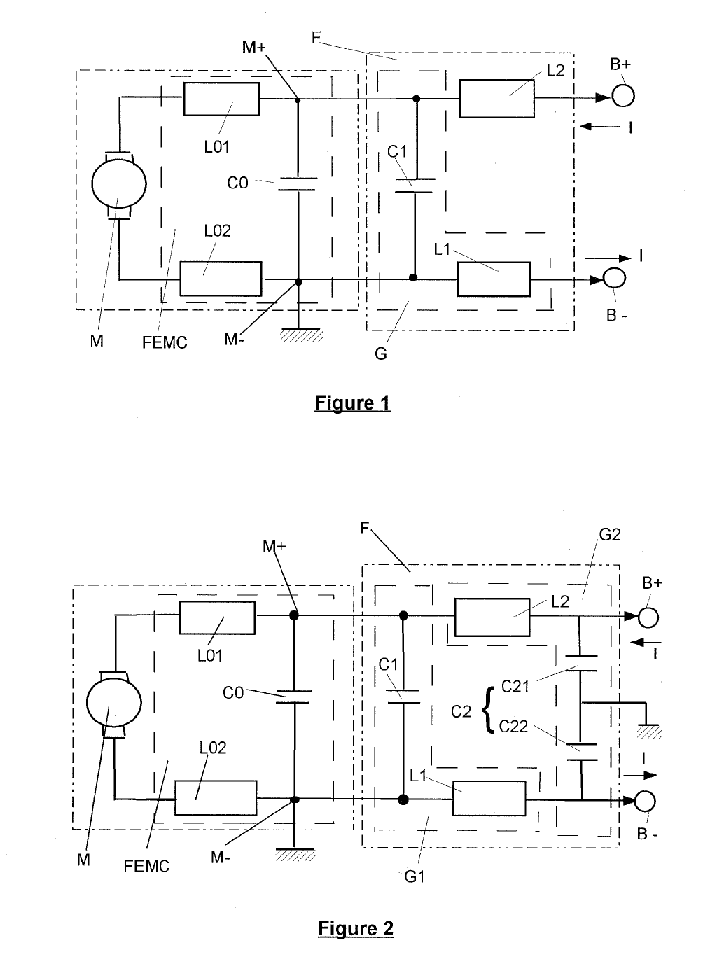

FIG. 1 depicts, by way of illustration, the electrical wiring diagram for a band attenuator/eliminator filter for the electromagnetic emissions of a brushed DC motor according to the subject matter of the present invention;

FIG. 2 depicts, by way of illustration, a preferred nonlimiting alternative form of the band attenuator/eliminator filter that forms the subject of the invention;

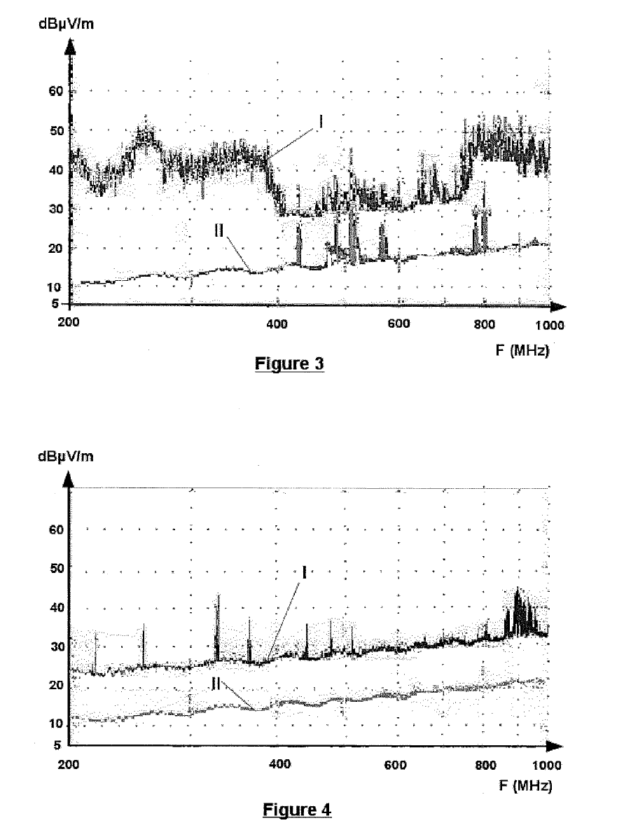

FIG. 3 depicts, by way of illustration, the frequency spectrum of the power supply voltage measured across the motor power supply terminals of a DC motor equipped with a conventional electromagnetic compatibility filter in the absence of the band attenuator/eliminator filter that forms the subject of the present invention; and

FIG. 4 depicts, by way of illustration, the frequency spectrum of the power supply voltage measured across the motor power supply terminals of a DC motor equipped not only with a conventional electromagnetic compatibility filter but also with a band attenuator/eliminator filter that forms the subject of the present invention.

The band attenuator/eliminator filter for the electromagnetic emissions of a brushed DC motor, that forms the subject of the invention, will now be described in conjunction with FIG. 1.

With reference to the abovementioned figure, it will be indicated that the band attenuator/eliminator filter that forms the subject of the invention comprises at least one gamma filter, so named with reference to the Greek letter Γ and denoted G, with capacitive C1/reactive L1 impedance, which is intended to be connected, as depicted in the abovementioned figure, between the motor negative power supply input M−, the motor positive power supply input M+ and the negative terminal B− of the battery. The capacitive impedance C1 is thus intended to be connected in parallel between the motor positive power supply input M+ and the motor negative power supply input M− and the reactive impedance L1 is intended to be connected between the motor negative power supply input M− and the negative terminal B− of the battery. The electromagnetic compatibility filter FEMC comprises, in the conventional way, a capacitance C0 and two reactive impedances L01, L02 which are inserted between the motor positive M+ and negative M− power supply terminals and the motor M.

Furthermore, as may be seen from FIG. 1, the band attenuator/eliminator filter that forms the subject of the invention comprises a reactive impedance L2 intended to be connected in series between the motor positive power supply input M+ and the positive terminal B+ of the battery.

The notion of a gamma filter is, by convention, defined in relation to the direction of the current I delivered by the battery, the capacitive impedance C1 and the reactive impedance L1 being deemed to constitute the abovementioned gamma filter G.

Adding the reactive impedance L2 in series on the power supply line via the positive power supply terminal B+ of the battery makes it possible to balance the attenuation of the mean level of the pulses of the transients of the switching of the brushes between commutator sectors across the two motor power supply lines that are connected to the positive B+ and negative B− terminals of the battery. The capacitive impedance C1 makes it possible to reduce the peak amplitude of the pulses and thus improves the common mode filter cancellation ratio.

According to one notable feature of the band attenuator/eliminator filter that forms the subject of the invention, the reactive impedances L1 and L2 advantageously have an impedance in excess of 100 Ohms in the frequency band comprised between 60 MHz and 1.5 GHz. The capacitive impedance C1 consists of a capacitor of the ceramic capacitor type with a capacitance comprised between 1 pF and 500 nF. The reactive impedances L1 and L2 preferably consist of ferrite core self-induction coils.

The preferred embodiment of the band attenuator/eliminator filter that forms the subject of the present invention is now described in conjunction with FIG. 2. With reference to the aforementioned figure, it is indicated that the band attenuator/eliminator filter that forms the subject of the invention further comprises a capacitive impedance C2 connected as shunt across the free terminals the reactive impedances L1 and L2, which are terminals not connected to the capacitive impedance C1, to form a symmetric closed filtering cell formed of a first gamma filter G1, consisting of the gamma filter G of FIG. 1, and a second gamma filter G2, mounted top to tail with the first gamma filter G1 and formed by the series reactive impedance L2 and the capacitive impedance C2 connected as shunt.

The capacitive impedance C2 connected as shunt consists of a capacitor, of the ceramic capacitor type, with a capacitance comprised between 5 and 10 pF. For preference, the capacitive impedance C2 is formed of a first capacitor C21 and a second capacitor C22 which are connected in series, and the mid-point of which is intended to be connected to the ground potential of the motor. The first capacitive impedance C21 and the second capacitive impedance C22 consist of a ceramic capacitor with the same electrical capacitance.

With reference to FIG. 2, it will be understood that the first gamma filter G1 and the second gamma filter G2, which constitute the symmetric closed structure that makes up the band attenuator/eliminator filter F that forms the subject of the invention, perform substantially the same role with respect to the motor negative power supply line M−, B− and with respect to the motor positive power supply line M+, B+ respectively. Further, this symmetric structure is also symmetric with respect to the ground potential of the motor because of the structure with a mid-point of the capacitive impedance C2 connected as shunt. Connecting this mid-point to the ground potential of the motor makes it possible to improve the common mode cancellation ratio of the band attenuator/eliminator filter that forms the subject of the invention.

A comparative evaluation of the attenuation of the induced parasitic noise or interference generated by a brushed DC motor, of the motor vehicle windshield wiper motor type, equipped with an electromagnetic compatibility filter FEMC, in the absence and, respectively, in the presence, of a band eliminator filter F according to the subject matter of the present invention, will be given in conjunction with FIGS. 3 and 4.

In the aforementioned figures, the abscissa axis is graduated for frequency, from 200 MHz to 1 GHz, the electromagnetic emissions attenuation if not elimination band of the band eliminator filter F that forms the subject of the invention, and the ordinate axis is graduated in dBμV/m, indicating the motor supply voltage amplitude values. In both figures, the recorded curve I represents the electrical field measured with an amplitude-peak detector and curve II represents the electrical field measured with a mean-value detector, in the absence of a band attenuator/eliminator filter F in the case of FIG. 3 and respectively in the presence of a band attenuator/eliminator filter F in the case of FIG. 4. It may be seen that inserting a band eliminator filter F as depicted in FIG. 2 introduces into the detected amplitude peak values for the electrical field, in curve I, a reduction of the order of 10 to 25 dBμV/m, and almost completely eliminates the mean amplitude parasitic noise spikes associated with the rotation of the motor, in curve II.

In general, it may finally be indicated that the band attenuator/eliminator filter F that forms the subject of the invention can be incorporated directly into the casing of the electromagnetic compatibility filter FEMC and therefore installed directly on any motor intended to be fitted to a motor vehicle as original equipment. By contrast, the band attenuator/eliminator filter F that forms the subject of the invention can also be inserted between the motor positive M+ and negative M− power supply terminals and the positive B+ and negative B− terminals of the battery, as a retrofit, on motors of the windshield wiper motor type, on existing vehicles already in circulation.

1. A band attenuator/eliminator filter for the electromagnetic emissions of a brushed DC motor, comprising:
one gamma filter with capacitive/reactive impedance intended to be connected between a motor positive power supply input, a motor negative power supply input and a battery negative terminal, the capacitive impedance being intended to be connected between the motor negative power supply input and the motor positive power supply input; and
a reactive impedance intended to be connected in series between the motor positive power supply input and the battery positive terminal.

2. The band attenuator/eliminator filter as claimed in claim 1, wherein said reactive impedances have an impedance in excess of 100 Ohms in a frequency band comprised between 60 MHz and 1.5 GHz.

3. The band attenuator/eliminator filter as claimed in claim 1, wherein said capacitive impedance consists of a capacitor with a capacitance comprised between 1 pF and 500 nF.

4. The band attenuator/eliminator filter as claimed in claim 1, further comprising: a capacitive impedance connected as a shunt across the free terminals of the reactive impedances to form a symmetric closed filtering cell formed of a first gamma filter, consisting of said gamma filter, and of a second gamma filter, mounted top to tail with the first gamma filter and formed by said series reactive impedance and said capacitive impedance connected as shunt.

5. The band attenuator/eliminator filter as claimed in claim 4, wherein said capacitive impedance connected as shunt consists of a capacitive impedance with a capacitance comprised between 5 and 10 pF.

6. The band attenuator/eliminator filter as claimed in claim 4, wherein said capacitive impedance connected as shunt is formed of a first capacitor and a second capacitor which are connected in series and the mid-point of which is intended to be connected to the ground potential of the motor.

7. The band attenuator/eliminator filter as claimed in claim 6, wherein the first capacitance and the second capacitance consist of a capacitor with the same electrical capacitance.

8. The band attenuator/eliminator filter as claimed in claim 1, wherein said filter is connected between the motor positive and negative power supply terminals and the positive and negative power supply terminals of the battery, said band eliminator filter being inserted between the electromagnetic compatibility filter (FEMC) incorporated into the motor and the power supply battery.

9. The band attenuator/eliminator filter as claimed in claim 7, wherein said filter is incorporated directly into the casing of the electromagnetic compatibility filter (FEMC).

10. The band attenuator/eliminator filter as claimed in claim 7, wherein said filter is retro-fitted between the electromagnetic compatibility filter (FEMC) incorporated into the motor and the power supply battery.

11. The band attenuator/eliminator filter as claimed in claim 1, wherein at least one reactive impedance consists of a ferrite core self-inductance coil.

12. The band attenuator/eliminator filter as claimed in claim 6, wherein the at least one of the first and second capacitor is of ceramic capacitor type.

13. A brushed DC motor, comprising a band attenuator/eliminator filter as claimed in claim 1.

14. The brushed DC motor as claimed in claim 13, wherein the brushed DC motor is used in a motor vehicle as a windshield wiper motor.
